(19) United States
(12) Patent Application Publication
(10) Pub. No.: US 2016/0189350 A1
(43) Pub. Date: Jun. 30, 2016

(54) SYSTEM AND METHOD FOR REMAPPING OF IMAGE TO CORRECT OPTICAL DISTORTIONS

(71) Applicant: Texas Instruments Incorporated, Dallas, TX (US)

(72) Inventors: John William Glotzbach, Allen, TX (US); Rajasekhar Reddy Allu, Plano, TX (US)

(21) Appl. No.: 14/586,670

(22) Filed: Dec. 30, 2014

(51) Int. Cl. G06T 5/00; H04N 5/225; G02B 13/00; G06T 1/60; H04N 5/262

(52) U.S. Cl. CPC G06T 5/006; G06T 1/60; H04N 5/2628; G02B 13/0015; H04N 5/2254

(57) ABSTRACT

Aspects of the present disclosure are drawn to a system and method for efficiently addressing the lens distortion problem in digital imaging. Aspects include a coarse mapping of the output pixel location position, further fine mapping of the pixel location position and interpolation of the pixel data. The coarse mapping of the output pixel location position and the fine mapping of the pixel location position are drawn to a back-mapping of output pixel location positions to the corresponding input pixel location positions.

### BACKGROUND

The present disclosure is generally drawn to correcting distortions in a digital image.

Digital imaging is the creation of a digital image from a physical scene. In many cases, a person takes a picture of an object using a digital camera, and that object is displayed on a pixelated screen, such as liquid crystal display screen. An example digital imaging system will now be described with additional reference to FIG. 1.

FIG. 1 illustrates a digital imaging system 100.

As shown, FIG. 1 includes an object 102, an output image 104, and a digital camera 106. Digital camera 106 further includes a lens 108, a sensor 110, and an image processor 112.

The digital imaging in the figure is viewed from left to right. Lens 108 is arranged between sensor 110 and object 102, so as to create an image of object 102 onto sensor 110 as shown by a line 114. Image processor 112 is arranged to receive data from sensor 110 via a line 116, so as to create a digital output image 104 onto a display (not shown) as shown by a line 118.

Digital camera 112 creates digital output image 104 associated with object 102. This is an example of any imaging system that uses a lens and image processing system to generate a digital image.

Lens 108 is an optical device that transmits and refracts light. In this example, lens 108 is shown as a single lens; however it can be any compound lens system that includes a plurality of lenses, sonic of which can be movable in order to focus an image 102 onto sensor 110. Sensor 110 is a device for the movement of electrical charge, usually from within the device to an area where the charge can be used, for example conversion into a digital value. Image processor 112 is any known signal processing system that is able to process image data provided by sensor 110 in order to generate output image 104. Output image 104, as shown in the figure as a digital image, can be provided to any known image output device and/or system; non-limiting examples include a liquid crystal display.

Lens 108 focuses an image of object 102 onto sensor 110. Sensor 110 outputs a stream of digital value bits corresponding to image processor 112. Image processor 112 processes the data from sensor 110 to generate output image 104. The problem with the digital imaging as shown in FIG. 1 is that output image 104 corresponds to the image that is generated onto sensor 110 by way of lens 108. In this manner, any aberrations generated by lens 108 will be imparted to output image 104.

The aberrations generated by the lens system can be corrected by the image processor 112, and there are many conventional ways of doing so. One conventional way is to use parametric models, which are lens distortions modeled by parametric equations with small sets of parameters that need to be configured. There are also remapping models that allow a device to take a map of input coordinates for a set of output coordinates. These conventional ways can be implanted on several engines, such as a general purpose processor, graphics processor, and digital signal processor. The general purpose processor is has flexible implementation, but can be very slow. The graphic processor consumes more power, is difficult to program, and is a resource that is often used by the system making access more difficult. Finally, the digital signal processor needs to be built: ahead of time to maximize performance. Large mapping tables add bandwidth used by the system and have limited use when they need to be recomputed in dynamic systems.

What is needed is an efficient system and method for addressing lens distortions in a digital imaging system.

### BRIEF SUMMARY

The present disclosure provides an efficient system and method for addressing lens distortions in a digital imaging system.

In accordance with aspects of the present disclosure, an image generator is provided for generating an output image. The image generator includes frame buffer processor circuitry, image area dividing processor circuitry and back-mapping processor circuitry. The frame buffer processor circuitry receives input image data associated with an input image that is associated with an input matrix of pixels. The input image data includes input pixel data corresponding to each pixel of the matrix of pixels, respectively. The image area dividing processor circuitry provides an output image area for the output image and divides the output image area into a plurality of subdivisions, The output image associated with an output matrix of pixels. The back-mapping processor circuitry selects an output pixel location in the output image area. The selected output pixel location corresponds to one of the plurality of subdivisions. The back-mapping processor circuitry further selects one of the input matrix of pixels based on the selected output pixel location and the location modification data and associates the input pixel data of the selected one of the input matrix of pixels with the selected output pixel location.

Additional advantages and novel features of the disclosure are set forth in part in the description which follows, and in part will become apparent to those skilled in the art upon examination of the following, or may be learned by practice of the disclosure. The advantages of the disclosure may be realized and attained by means of the instrumentalities and combinations particularly pointed out in the appended claims.

### BRIEF SUMMARY OF THE DRAWINGS

The accompanying drawings, which are incorporated in and form a part of the specification, illustrate an exemplary embodiment of the present disclosure and, together with the description, serve to explain the principles of the disclosure. In the drawings:

FIG. 1 illustrates a digital imaging system;

FIG. 2 illustrates an input image on a sensor of a digital imaging system;

FIG. 3 illustrates an output image;

FIG. 4 illustrates an example digital imaging system in accordance with aspects of the present disclosure;

FIG. 5 illustrates an exploded view of an example of the image processing system in FIG. 4;

FIG. 6 illustrates a method for processing an image in accordance with aspects of the present disclosure;

FIG. 7 illustrates a coarse displacement block boundary;

FIG. 8 illustrates an image block boundary, in accordance with aspects of the present disclosure;

FIG. 9 illustrates a sectioned output area in accordance with aspects of the present disclosure;

FIG. 10 illustrates an initial back mapping process in accordance with aspects of the present disclosure;

FIG. 11 illustrates an interpolation process for one adjustment of the pixel location positions accordance with aspects of the present disclosure;

FIG. 12 illustrates an interpolation process for adjustment of the pixel data in accordance with aspects of the present disclosure;

FIG. 13 illustrates an exploded view of a subdivision of FIG. 9, as further sub-divided in accordance with aspects of the present disclosure; and

FIG. 14 illustrates the relationship between a frame, a block, a coarse data sub-division area and a final pixel-level subdivision area in accordance with aspects of the present disclosure.

### DETAILED DESCRIPTION

Aspects of the present disclosure are drawn to a system and method for efficiently addressing the lens distortion problem in digital imaging. Aspects include a coarse mapping of the output pixel location position, further fine mapping of the pixel location position and interpolation of the pixel data.

The coarse mapping of the output pixel location position and the fine mapping of the pixel location position are drawn to a back-mapping of output pixel location positions to the corresponding input pixel location positions.

In the coarse mapping of the output pixel location position, the output image area is divided into subdivisions. Each subdivision is provided with an associated predetermined coordinate displacement which back-maps the location of that subdivision in the output image area to a corresponding input image area. In this manner, sections of the output image area are mapped to sections of the input image area. By back-mapping sections of area, as opposed to individual pixels, a controller generates less coarse displacement data. Based on system band width and quality requirements, users can fine tune the size of subdivision.

In the fine mapping, each of the previously subdivided areas is farther subdivided into pixel level. Each pixel is provided with an associated interpolated coordinate displacement which more finely back-maps the location of that smaller subdivision in the output image area to a corresponding input image area. In this manner, each pixel of the output image area is finely mapped to a pixel position in the input image area. Interpolating small sections of subdivisions of area to generate pixel level fine displacement, as opposed to fetching all displacement data from external memory, saves memory band width by magnitudes.

Once the output pixel locations have been properly positioned, the data for each output pixel location (from an associated input pixel) is generated with either bi-cubic or bi-linear interpolation. Similar to the interpolation discussed, above, the data for each output pixel is modified based on an interpolation with surrounding pixels. By interpolating pixels drastic changes in the modified image are smoothed.

Aspects of the present disclosure will now be described with reference to FIGS. 2-11.

As discussed above, aberrations and deformations in a digital imaging system need to be corrected before an output image is created. An example system and method in accordance with aspects of the present disclosure that address such aberrations and deformations will now be described with reference to FIG. 2 and FIG. 3.

FIG. 2 illustrates an input image 200 on a sensor of a digital imaging system in accordance with aspects of the present disclosure.

As shown in the figure, input image 200 includes an input image area 202, an input object image 204, and an unused area 206.

Input image area 202 is configured to show the entire region of sensor 110. Inside input image area 202 are input object image 204, and unused area 206.

Input image area 202 is the area of a sensor used in digital imaging to convert an electrical charge into a digital value. Within input image area 202 is input object image 204, which is the image that is projected through a lens and captured by sensor area 110. Unused area 206 is the region of the sensor that did not capture any image. To clarify, the lens in the camera will determine how much of the input image area 202 will be used.

For purposes of this discussion, presume that input image 200 is generated using a conventional lens system onto a conventional sensor. Further, presume that the image of the object should have a corresponding input image that resides in input image area 202. However, the lens system will have an associated aberration. In this example, the lens system (not shown) creates such an aberration that a normally rectangular image is transformed onto input image area 202 as a circular image. The result is seen as input object image 204, which was deformed by the aberration associated with the lens system, thereby leaving the remaining unused area 206 with no image.

In accordance with aspects of the present disclosure, the input image of FIG. 2 will be adjusted to compensate for the aberrations generated by the lens system to provide a corrected output image. This will be described with additional reference to FIG. 3.

As shown in the figure, output image 300 includes an image area 302, and an output object image 304.

Image area 302 is configured to show the entire region of the corrected output image. Inside of this region is output object image 304.

Image area 302 is configured to show the output result after undergoing the digital imaging process from input to output. Within image area 302 is output object image 304 that corresponds to input object image 204 after going through a digital imaging process in accordance with aspects of the present disclosure.

For this discussion, presume input object image 204 is created by a conventional lens system and a conventional sensor. The input image captured onto the sensor (shown in FIG. 2) will have its data streamed into a system of the present disclosure, which will process the data by back mapping. Section by section, the image processor will correct the input image of its aberrations and produce an output object image seen in FIG. 3.

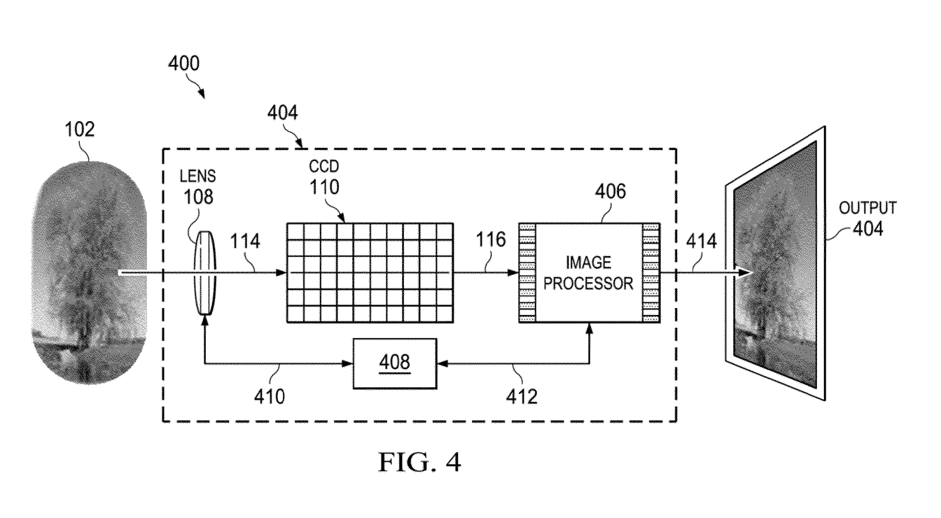

The image processing system described in the previous section is used to produce an undistorted output image. The image processor will take a distorted image seen in FIG. 2 and correct the image to create an undistorted image seen in FIG. 3. A system and method of processing imaging data in accordance with aspects of the present disclosure will now be described with reference to FIGS. 4-12.

FIG. 4 illustrates an example digital imaging system 400 in accordance with aspects of the present disclosure.

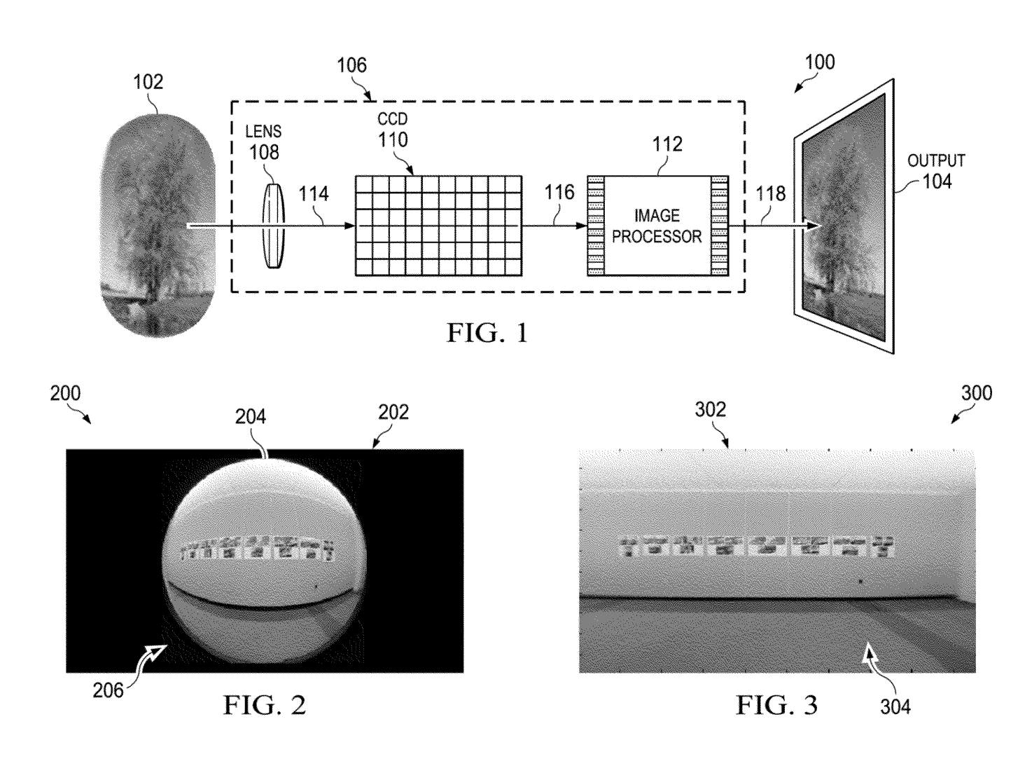

As shown, FIG 4 includes object 102, an output image 402, and a digital camera 404. Digital camera 404 is differs from digital camera 106 described above with reference to FIG. 1 in that image processor 112 of digital camera 106 has been replaced with image processor 406 and digital camera 404 additionally includes a controller 408.

Controller 408 is communicates with lens 108 via a communication line 410 and communicates with image processor 406 via a communication line 412. Image processor 406 is arranged to receive data from sensor 110 via line 116, so as to create output image 402 onto a display not shown) as shown by a line 414.

Image processor 406 may any known signal processing system that is able to process image data provided by sensor 110 in order to generate output image 402 in accordance with aspects of the present disclosure. Output image 402, as shown in the figure as a digital image, can be provided to any known image output device and/or system; non-limiting examples include a liquid crystal display.

In this embodiment, each of image processor 406 and controller 408 are illustrated as distinct devices. However, in other embodiments, image processor 406 and controller 408 may be combined as a unitary device. Further, in some embodiments, at least one of image processor 406 and controller 408 may be implemented as a tangible computer-readable media for carrying or haying computer-executable instructions or data structures stored thereon. Such tangible computer-readable media can be any available media that can be accessed by a general purpose or special purpose computer. Non-limiting examples of tangible computer-readable media include physical storage and/or memory media such as RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a tangible computer-readable medium. Thus, any such connection is properly termed a tangible computer-readable medium. Combinations of the above should also be included within the scope of tangible computer-readable media.

In operation, controller 408 controls image processor 406 to adjust input image produced by sensor 100 to reduce distortions in output image 402. Because the distortions are associated with lens 108, or more particularly the state of lens 108, controller 408 instructs image processor 408 based on lens 108, or the state of lens 108.

In some embodiments, lens 108 is associated with image processor 406 and controller 408, e.g., they are manufactured as a unitary device. In these embodiments, lens 108 will create a specific, known distortion and image processor 406 will compensate for this specific, known distortion in a predetermine manner. Further, controller 408 will be able to provide image processor 406 with appropriate information for lens 108, which will create a specific known distortion. The appropriate information may take the form of a distortion signal indicating the type and/or amount of distortion created in the image by lens 108.

In some embodiments. lens 108 may be one of many lenses that are replaceable relative to image processor 406 and controller 408. As such, in these embodiments, the replaceable lenses will create specific, known distortions, respectively, and image processor 406 will compensate for each specific, known distortions in a respective predetermine manner. Further, controller 408 will be able to provide image processor 406 with appropriate information for different lens, which will each create different distortions.

In some embodiments, lens 108, may be an adjustable lens system, wherein the varied focal adjustments create different distortions. As such, in these embodiments, the adjustable lens system will create specific, known distortions, respectively, based on the varied tens positions and image processor 406 will compensate for each specific, known distortions in a respective predetermine manner. Further, in some embodiments, controller 408 is able to detect the specific position of the lenses in the adjustable lens system, and will be able to provide image processor 406 with appropriate information for the specific position of the lenses.

With the appropriate information related to lens 108, controller will: 1) coarsely adjust the output image by: a) dividing, an output image area, e.g., the area for which a final output image will reside, into subdivisions; and b) back-mapping each subdivision of the output image area to a respective area of the input image, e.g., the area of the image generated by sensor 110, wherein the back-mapping is based on the known distortion of lens 108; 2) finely adjust the output image by: a) subdividing each output image area subdivision into smaller subdivisions; and b) interpolating to calculate a fine position adjustment for each smaller subdivision; and 3) associating the input data for each pixel at each input image area, with the corresponding pixel at the adjusted output position to generate final output image 402.

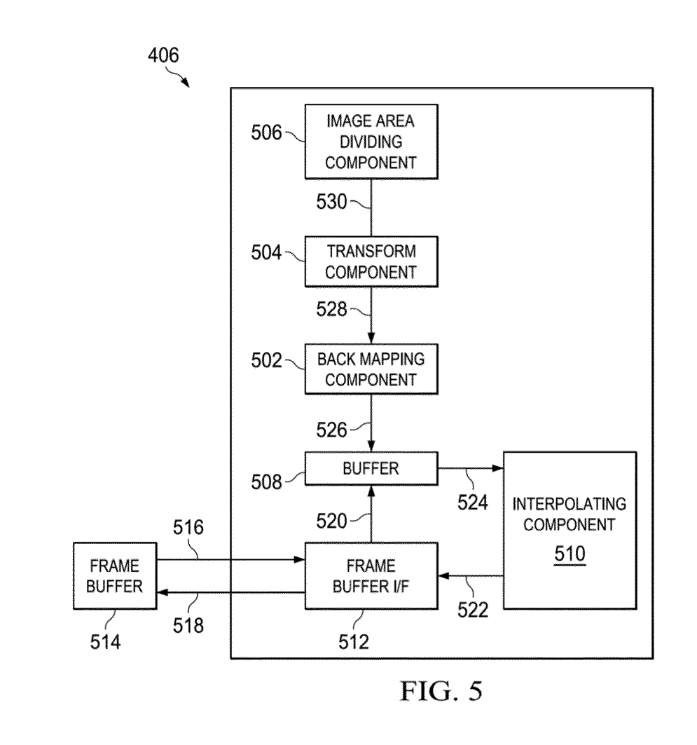

A more detailed discussion of digital imaging system 410 will be described with reference to FIGS. 5-11.

FIG. 5 illustrates an exploded view of an example image processing system 406 in accordance with aspects of the present disclosure.

As shown in the figure, image processing system 406 includes back-mapping processor circuitry 502, transform processor circuitry 504, image dividing processor circuitry 506, a buffer 508, interpolating processor circuitry 510, a frame buffer I/F 512, and frame buffer processor circuitry 514. In this embodiment, each of back-mapping processor circuitry 502, transform processor circuitry 504, image dividing processor circuitry 506, buffer 508, interpolating processor circuitry 510, frame buffer I/F 512 and frame buffer processor circuitry 514 are illustrated as distinct devices. However, in other embodiments, at least two of back-mapping processor circuitry 502, transform processor circuitry 504, image dividing processor circuitry 506, buffer 508, interpolating processor circuitry 510, frame buffer I/F 512 and frame buffer processor circuitry 514 may be combined as a unitary device. Further, in some embodiments, at least one of back-mapping processor circuitry 502, transform processor circuitry 504, image dividing processor circuitry 506, buffer 508, interpolating processor circuitry 510, frame buffer I/F 512 and frame buffer processor circuitry 514 may be implemented as a tangible computer-readable media for carrying or baying computer-executable instructions or data structures stored thereon.

Frame buffer processor circuitry 514 is arranged to output data to frame buffer I/F 512 by way of line 516. Frame buffer processor circuitry 514 is additionally arranged to receive data from frame buffer I/F 512 by way of line 518. Frame buffer I/F 512 is arranged to output data to buffer 508 by way of line 520. Frame buffer I/F 512 is additionally arranged to receive data from interpolating processor circuitry 510 by way of line 522. Buffer 508 is arranged to output data to interpolating processor circuitry 510 by way of line 524. Buffer 508 is additionally arranged to receive data from back-mapping processor circuitry 502 by way of line 526. Back-mapping processor circuitry 502 is arranged to input and receive data from transform processor circuitry 504 by way of line 528. Transform processor circuitry 504 is arranged to receive data from image area dividing processor circuitry 506. In this example embodiment, data along lines 530, 528, 526, data long lines 524 and 522 corresponds to pixel data and data along lines 516, 518 and 520 corresponds to pixel data and pixel location data.

Image area dividing processor circuitry 506 is operable to provide an output image area for the output image and to divide the output image area into a plurality of subdivisions.

Back-mapping processor circuitry 502 is operable to select an output pixel location in the output image area. Back-mapping processor circuitry 502 is further operable to select one of the input pixels based on the selected output pixel location and the location modification data and associate the input data of the selected input pixel with the selected output pixel location. Back-mapping processor circuitry 502 is additionally operable to interpolate a final output pixel coordinate.

Transform processor circuitry 504 has stored location coordinate change data based on the type of lens system being used. Buffer 508 holds the image information Interpolating processor circuitry 510 is operable to interpolate a pixel data of the output pixels.

Frame buffer processor circuitry 514 is operable to receive input image data associated with an input image. The input image data includes input pixel data corresponding to each pixel contained in the input image. Frame buffer I/F 512 is operable to map input image data onto the buffer 508.

Image area dividing processor circuitry 506 determines the size of the output and divides the output image into a group of subdivisions. Back-mapping processor circuitry 502 chooses an output location coordinate to back map to the input image.

Transform processor circuitry 504 will perform transformations for user specific special operations (like scaling, rotating and etc.). Such transformations include transformations to the pixel location and pixel data associated with an input image. Transform processor circuitry 504 determines a Δx and Δy coordinate to add to the output coordinates to back map output image area subdivision to the input image area. Transform processor circuitry 504 uses tables to describe the transformation of output coordinates to input coordinates. In some embodiments, these tables may be provided by controller 408. In some embodiments, they are stored in transform processor circuitry 504. The tables define a relative offset from the output image area position. Input image area position is determined by adding the offset (Δx, Δy) to the output image area position. The offset (Δx, Δy) is used by back mapping block 502.

The input image block and coarse displacement block are determined for corresponding output subdivision and the output image area subdivision is provided via the local image butler 508.

Once the output image pixel location is computed, frame buffer I/F 512 pulls the data values for all pixels within the block from frame buffer processor circuitry 514. The pixel data value for each input image pixel from frame buffer processor circuitry 514 is provided, back into buffer 508. This process continues until the pixel values for all the pixels for all the subdivisions are retrieved.

The final output image pixel location is computed by interpolating within the output image subdivision neighborhood by back-mapping processor circuitry 502.

Next, the pixel data for each input pixel is modified via interpolating processor circuitry 510 to obtain pixel data for each corresponding output pixel.

This cycle will continue until a corrected output image is completely generated.

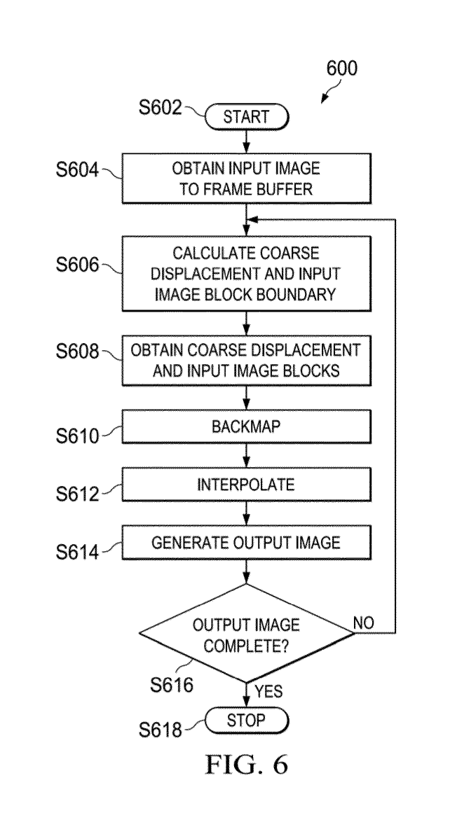

A method of processing imaging data in accordance with aspects of the present disclosure will now be described with reference to FIG. 6.

FIG. 6 illustrates a method 600 for processing an image in accordance with aspects of the present disclosure.

As shown in the figure, method 600 starts (S602) and an input image is obtained (S604). For example, returning to FIG. 4, object 102 is focused on through lens 108 and is projected onto sensor 110. The result of object 102 on sensor 110 can be seen in FIG. 2. Next, the input image generated by sensor 110 is provided to image processor 406. As shown in FIG. 5, the input image is input into image processing system 406 by frame buffer processor circuitry 514.

Returning to FIG. 6, once the input image is obtained (S604), the image block boundary is determined (S606). For example, returning to FIG. 5, transform processor circuitry 504 and back-mapping processor circuitry 502 transform output image area blocks into input image area blocks. For each block of output image data to be created, it must be determined as to how much input data must be gathered. This will be described in greater detail with reference to FIG. 7.

FIG. 7 illustrates a coarse displacement block boundary, in accordance with aspects of the present disclosure.

FIG. 7 includes an output block 702, having four corners 704, 706, 708 and 710. FIG. 7 further includes perspective warp coordinate (output of transform processor circuitry 504) locations represented by circles 712, 714, 716 and 718. The figure still further includes a bounding box 720, sub-blocks 722, 724, 726 and 728, and a coarse displacement data boundary 730.

Output block 702 corresponds to the resultant block of output pixels for which data will be assigned for a given amount of input data that must be retrieved.

Circle 712 corresponds to an input data pixel location that corresponds to the pixel of output block 702 located at corner 704. Circle 714 corresponds to an input data pixel location that corresponds to the pixel of output block 702 located at corner 706. Circle 716 corresponds to an input data pixel, location that corresponds to the pixel of output block 702 located at corner 708. Circle 718 corresponds to an input data pixel location that corresponds to the pixel of output block 702 located at corner 710.

Bounding box 720 hounds the area that includes all of perspective warp coordinate locations represented by circles 712, 714, 716 and 718.

Sub-block 722 corresponds to a subdivision of input pixels that share the same coarse displacement, i.e., the same Δx and Δy coordinate to add to the output coordinates, as the input pixel located at circle 712. Sub-block 724 corresponds to a subdivision of input pixels that share the same coarse displacement as the input pixel located at circle 714. Sub-block 726 corresponds to a subdivision of input pixels that share the same coarse displacement as the input pixel located at circle 716. Sub-block 728 corresponds to a subdivision of input pixels that share the same coarse displacement as the input pixel located at circle 718.

Coarse displacement data boundary 730 bounds the area that includes all of sub-blocks 722, 724, 726 and 728.

To determine which input pixel data must be gathered for a resulting output block of data, transform processor circuitry 504 first determines the corners of the output block. In this example, the corners are corners 704, 706, 708 and 710. Then, transform processor circuitry 504 determines the corresponding input pixel locations for the corners. In this example, the corresponding input pixel locations are perspective warp coordinate locations represented by circles, 712, 714, 716 and 718. Then, transform processor circuitry 504 determines a rectangular area of the input pixels that includes the input pixel locations that correspond to the corners of the output block. In this example, the rectangular area is that bounded by bounding box 720. Finally, transform processor circuitry 504 determines the final amount of input pixels for which data must be gathered for a resulting output blocks of data by including, the rectangular area that includes the sub-blocks that include the input pixel locations that correspond to the corners of the output block. In this example, the final amount of input pixels includes those within coarse displacement data boundary 730.

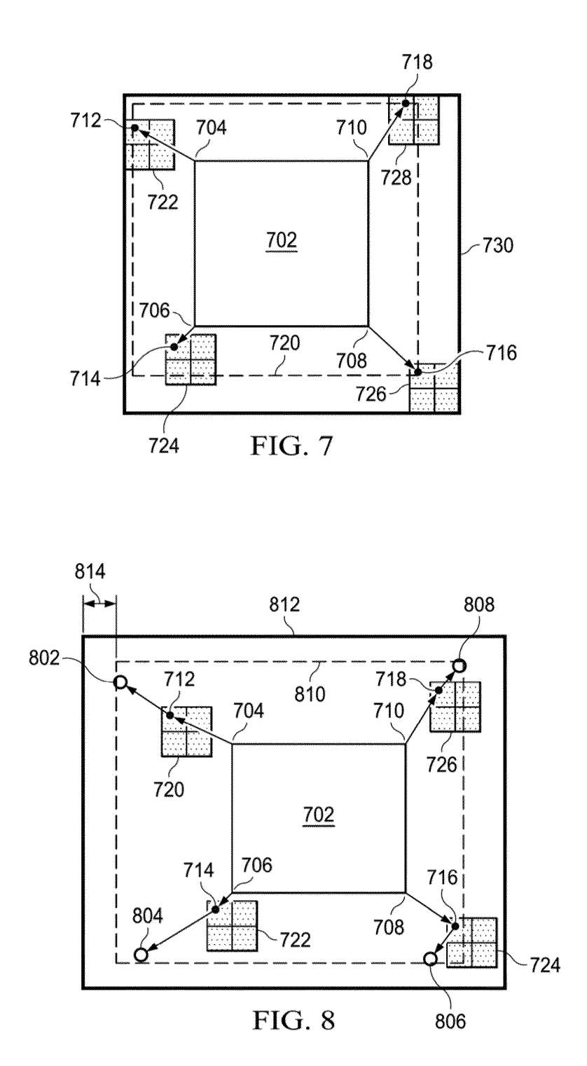

Returning to FIG. 6, once the image block boundary is determined (S606) and the image block boundaries are obtained (S608). This will be described in greater detail with reference to FIG. 8.

FIG. 8 illustrates an image block boundary, in accordance with aspects of the present disclosure.

FIG. 8 includes output block 702, four corners 704, 706, 708 and 710, perspective warp coordinate locations represented by circles 712, 714, 716 and 718, and sub-blocks 720, 722, 724 and 726. FIG. 8 further includes back-mapped coordinate locations represented by circles 802, 804. 806 and 808, a bounding box 810 and an image data boundary 812.

Circle 802 is the output data pixel location that is the result of back-mapping circle 712. Circle 804 is the output data pixel location that is the result of back-mapping circle 714. Circle 806 is the output data pixel location that is the result of back-mapping circle 716. Circle 808 is the output data pixel location that is the result of back-mapping circle 718.

Bounding box 810 corresponds to the area that includes all of back-mapped coordinate locations represented by circles 802, 804, 806 and 808.

Image data boundary 812 corresponds to the area that includes all of sub-blocks 722, 724, 726 and 728. Image data boundary 812 is larger than bounding box 810 by a margin indicated by double arrow 814.

Returning to FIG. 7, after transform processor circuitry 504 determines the final amount of input pixels included within coarse displacement data boundary 730, perspective warp coordinate locations represented by circles 712, 714, 716, and 718 are back-mapped to determine the new output data pixel locations to populate the output pixels within output block 702.

With perspective warp coordinate locations represented by circles 712, 714, 716, and 718, transform processor circuitry 504 determines the Δx coordinate and Δy coordinate based on the lens system being used. This information is passed onto back-mapping component 502, as seen in FIG. 5, which then adjusts the displacement of perspective warp coordinate locations represented by circles 712, 714, 716, and 718, by Δx and Δy to produce back-mapped coordinate locations represented by circles 802, 804, 806 and 808, respectively. The resulting four back-mapped coordinate locations represented by circles 802, 804, 806 and 808 produces bounding box 810 that includes the output pixel locations that corresponds to the back-mapped coordinate locations. Finally, the final amount of output pixels for which data must be gathered for a resulting output blocks of data by including the rectangular area that includes the sub-blocks that include the output pixel locations that correspond to the back-mapped coordinate locations is included within image data boundary 812. The displacement between the image data boundary 812 and bounding box 810 is given by output coarse displacement 814.

Returning to FIG. 6, now that the coarse displacement and input image blocks have been obtained (S608), a back-mapping process is performed. For example, as shown in FIG. 5, back-mapping processor circuitry 502 performs such a back-mapping process.

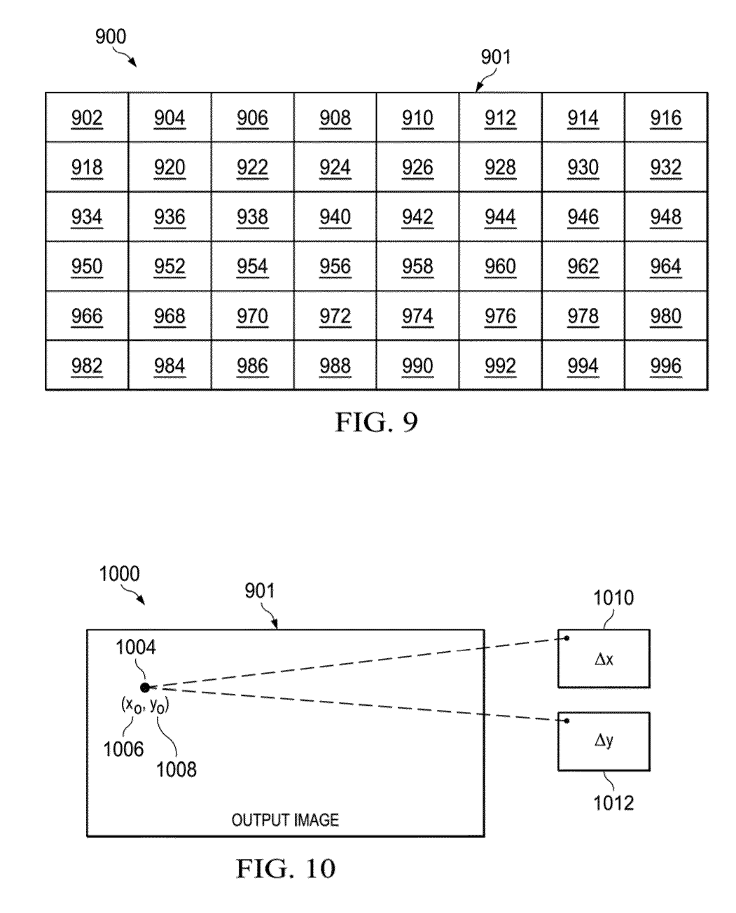

An example of back-mapping in accordance with aspects of the present disclosure will now be further described in detail with reference to FIGS. 9-11.

FIG. 9 illustrates a sectioned output area 900 in accordance with aspects of the present disclosure.

As shown in the figure, sectioned output area 900 includes subdivisions 902 through 996.

Unlike some conventional systems, which may map an output image to an input image on a pixel by pixel basis, an example system in accordance with aspects of the present disclosure divides an output image area into N×M subdivisions, where N and M are integers. In some embodiments, N=M, whereas in other embodiments, N≠M. Image area dividing processor circuitry 506 divides the output image area into subdivisions 902 through 996. As such, in this non-limiting example, the output image area is divided into 8×6 subdivisions, where N=8 and M=6. This information is passed on to the back-mapping component 502.

FIG. 10 illustrates the initial back mapping process 1000 in accordance with aspects of the present disclosure.

As shown in the figure, initial back mapping process 1000 includes output area 901, an output image location 1004, a xₒ coordinate 1006, a yₒ coordinate 1008, a Δx coordinate 1010, and a Δy coordinate 1012.

Output area 901 is the area for which a final output image will reside. Output image location 1004 is an example position used to illustrate the back mapping process. Output image location 1004 is positioned at xₒ (1006) and yₒ (1008). Δx coordinate 1010 is the associated position change in an x direction that coarsely maps pixels, within in the subdivision of the output image area corresponding to output image location 1004, to the corresponding input image area. Δy coordinate 1012 is the associated position change in a y direction that coarsely maps pixels, within in the subdivision of the output image area corresponding to output image location 1004, to the corresponding input image area.

It should be noted that, non-limiting embodiment of the course mapping in a Cartesian coordinate system is provided for purposes of discussion. Any coordinate system may be used wherein a change in the coordinates is used for coarsely back-mapping pixels within a section of the output image area to a corresponding section of the input image area.

Coarse mapping, is based on the known distortion associated with lens 108. As noted previously, if the lens is able to be variably focused then the Δx and Δy coordinates will be provided based on the state of the lenses. Δx coordinate 1010 and Δy coordinate 1012 are stored coordinates from a predetermined database that are used to back map from output image coordinate 1004 to the input object image 204.

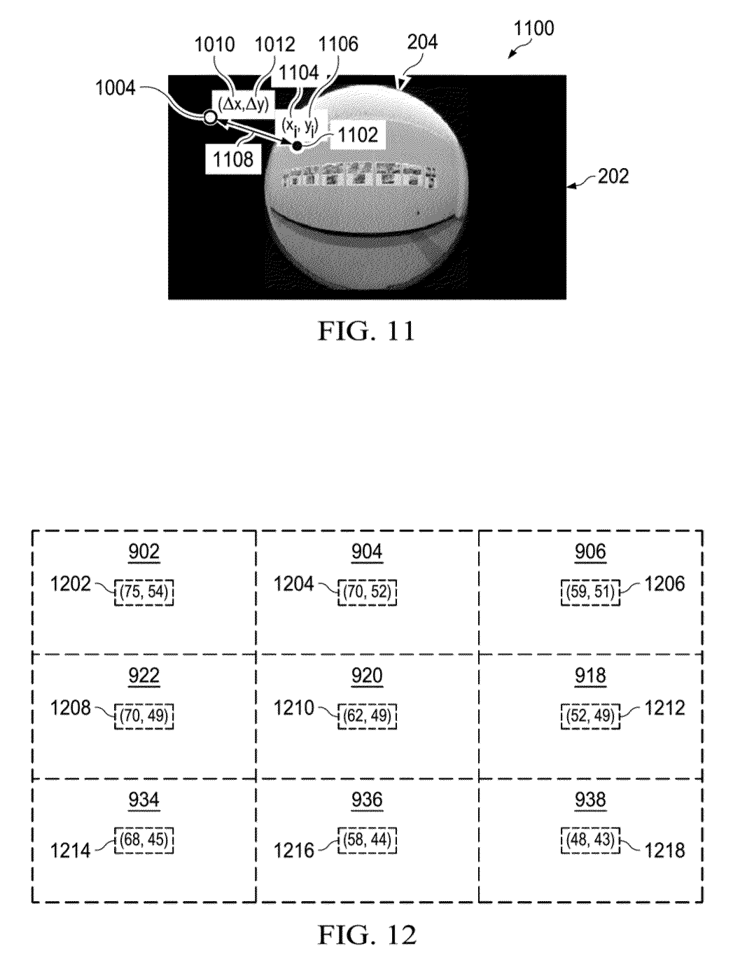

In this example, an example point, output image location 1004, is positioned at xₒ location 1006 and yₒ location 1008. With the selected location, transform processor circuitry 504 determines the Δx coordinate 1010 and Δy coordinate 1012 based on the lens system being used, This data will be stored and move into the final stage of the back mapping process, which will be further described in reference to FIG. 11.

FIG. 11 illustrates an example of the coarse adjustment of the output image using back-mapping in accordance with aspects of the present disclosure.

As shown in the figure, information transfer process 1100 includes input image area 202, input object image 204, output image coordinate 1004, Δx coordinate 1010, Δy coordinate 1012, an input Image location 1102, a xᵢ coordinate. 1104, and a yᵢ coordinate 1106.

Input image location 1102 is a location on input object image 204 that has xᵢ coordinate 1104 and yᵢ coordinate 1106. Input image coordinate 1102 is determined when output image coordinate 1004 back maps per Δx coordinate 1010 and Δy coordinate 1012.

The back mapping process begins by taking output image location 1004 with xₒ coordinate 1006 and yₒ coordinate 1008 and adding Δx coordinate 1010 and Δy coordinate 1012 per the equation 1 below.

(xᵢ, yᵢ)=(xₒ+Δx, yₒ+Δy) (1)

Equation (1) generates xᵢ coordinate 1104 and yᵢ coordinate 1106 for input image location 1102,

For example, returning to FIG. 5, back-mapping component 502 receives information from both image area dividing processor circuitry 506 and transform processor circuitry 504. Referring to FIG. 9, image area dividing processor circuitry 506 provides a map of output to input coordinates and divides the output image area into N×M subdivisions, where N and M are integers, in some embodiments, N=M, whereas in other embodiments, N≠M.

In some embodiments, image area dividing processor circuitry 506 divides the output image area into non-Cartesian subdivisions. A non-limiting, example of which includes image area dividing processor circuitry 506 dividing the output image area into polar/radial subdivisions.

The subdivided area being processed and the corresponding course back-mapping. information are passed back to back-mapping component 502.

For purposes of discussion, returning to FIG. 9, let subdivision 920 be a subdivision that is being interpolated. In this example as shown in FIG. 10, output image location 1004 is positioned at xₒ (1006) and yₒ (1008). With the selected location, transform processor circuitry 504 has the corresponding Δx coordinate 1010 and Δy coordinate 1012 stored therein. The transformed coordinates are predetermined a priori information that is associated with the lens system being used. This information may be stored as subsampled tables in back-mapping component 502.

Next, returning to FIG. 11, output image location 1004, with xₒ coordinate 1006 and yₒ coordinate 1008, is modified by adding Δx coordinate 1010 and Δy coordinate 1012 per the equation (1). Equation (1) generates xᵢ coordinate 1104 and yᵢ coordinate 1106 for the coarsely adjusted output image location corresponding to input image location 1102.

Returning to FIG. 6, now that the initial portion of the back-mapping process is complete (S610), an interpolation is performed (S612). For example, as shown in FIG. 5, back-mapping processor circuitry 502 takes the coordinates stored in buffer 508 from the initial portion of the back-mapping, process and interpolates them. For interpolation, each subdivision is further subdivided. For purposes of discussion, an example of interpolation of subdivision 920 will be described.

Referring to FIG. 9, image area dividing processor circuitry 506 divides each previously created subdivision further into n×m in subdivisions, where n and m are integers. In some embodiments, n=m, whereas in other embodiments, n≠m. In some embodiments, the number N=n, whereas in other embodiments, N≠n. In some embodiments, M=m, whereas in other embodiments, M≠m. In some embodiments, each further subdivision is a single pixel.

In some embodiments, image area dividing processor circuitry 506 divides each previously created subdivision into non-Cartesian subdivisions. A non-limiting example of which includes image area dividing processor circuitry 506 dividing each previously created subdivision into polar/radial subdivisions.

The further subdivided area being processed and the corresponding coarse back-mapping information are already within back-mapping processor circuitry 502.

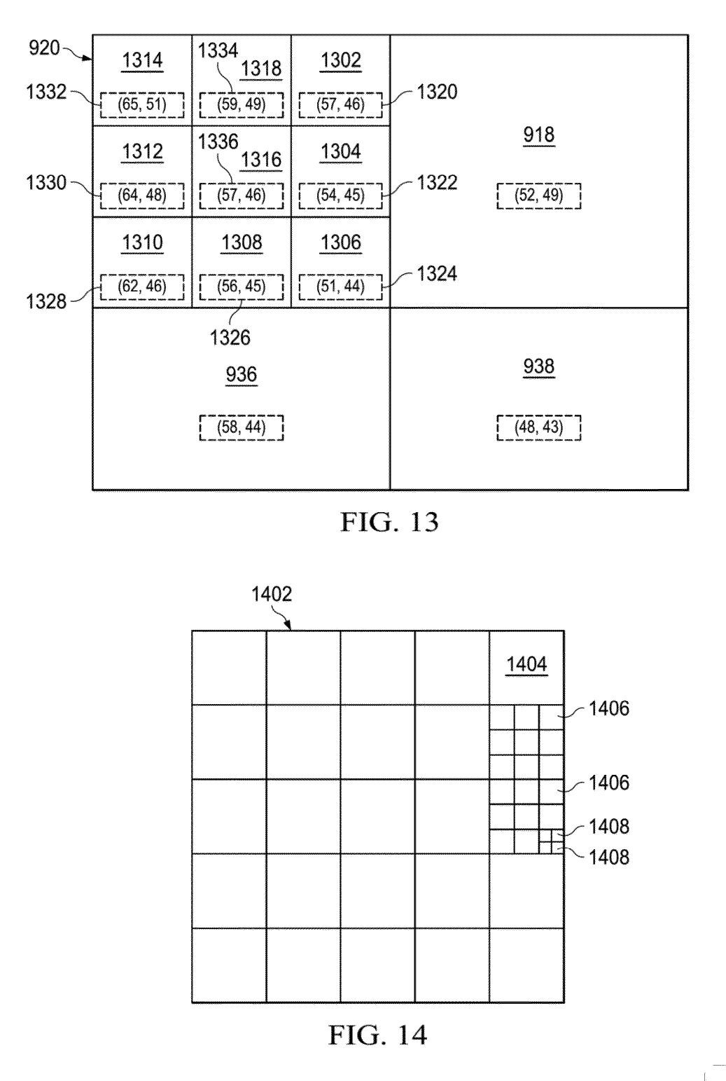

This process will be further described with reference to FIGS. 12-13.

A method of interpolating to finely alter the output pixel position location in accordance with aspects of the present disclosure will now be described with additional reference to FIG. 12.

FIG. 12 illustrates an exploded view of subdivisions 902, 904, 906, 918, 920, 922, 934, 936 and 938 of FIG. 9.

As shown in the figure, each of subdivisions 902, 904, 906, 918, 920, 922, 934, 936 and 938 are illustrated with a corresponding pair of delta coordinates, indicated as evenly numbered items 1202 through 1218, respectively.

Each pair of delta coordinates corresponds to the amount that all the pixel locations within a particular subdivision of the output image area is to be modified in the x and y direction. For example, all pixels located within subdivision 920 will be coarsely shifted in the x-direction by 62 pixels and will be shifted in the v-direction by 49 pixels as indicated by item 1210. Similarly, all pixels located within subdivision 918 will be coarsely shifted in the x-direction by 52 pixels and will be coarsely shifted in the y-direction by 49 pixels as indicated by item 1212. This course shifting corresponds to the initial back-mapping discussed above. Once back mapped, the output image is more finely modified.

FIG. 13 illustrates an exploded view of subdivision 920, as further sub-divided in accordance with aspects of the present disclosure.

FIG. 13 includes subdivision 918, subdivision 920, subdivision 936 and subdivision 938.

For purposes of discussion, interpolation of subdivision 920 will be described. In this non-limiting example, a bilinear immolation is performed. As mentioned above, each subdivision may be divided in the n×m, further subdivisions. In some example embodiments, each subdivision is further subdivided all the way down to where each further subdivision includes a simile pixel. For purposes of discussion, subdivision 920 is further divided into 3×3 subdivisions as seen in FIG. 13. Subdivision 920 includes evenly numbered subdivisions 1302 through 1318. Each of evenly numbered subdivisions 1302 through 1318 has a corresponding pair of delta coordinates, indicated as evenly numbered items 1320 through 1336, respectively.

Each pair of delta coordinates, indicated as evenly numbered items 1320 through 1336, respectively, corresponds to the amount that all the pixel locations within a particular subdivision of the output image area is to be ultimately modified in the x and y direction. In accordance with an aspect of the present disclosure, each pair of delta coordinates, indicated as evenly numbered items 1320 through 1336, respectively, will be calculated using interpolation.

Any known interpolation method may be used. For this discussion, interpolation will performed for a subdivision using the back mapped delta coordinates of neighboring subdivisions, For example, for subdivision 920, the bilinear interpolation uses subdivision 936 (below), subdivision 938 (down and to the right) and subdivision 918 (to the right). By using the back mapped delta coordinates of subdivision 936, subdivision 938 (down and to the right) and subdivision 918, the interpolated coordinates of subdivisions 1302-1318 are calculated. For example, all pixels located within subdivision 1302 sill be ultimately shifted in the x-direction by 57 pixels and will be shifted in the y-direction by 46 pixels as indicated by item 1320. Similarly, all pixels located within subdivision 1312 will be ultimately shifted in the x-direction by 64 pixels and will be shifted in the y-direction by 48 pixels as indicated by item 1330.

Now that the interpolation has been completed, each subdivision 1302 through 1318 will have a new interpolated fine displacement value. The new interpolated displacement values fur coordinates 1320 through 1336 will map output pixel location to input pixel location and pixel data back to the output image and begin boning the corrected output image. This process will continue until subdivisions 902 through 996 are generated through the interpolation process.

Returning to FIG. 6, now that the interpolation is complete (S612), an output block of image is generated (S614). For example, the interpolated values will shift pixel location from the output image area location and to the corresponding input image area location. Then the data values for each pixel in the input image is output to the corresponding output pixel location, by taking the information stored in buffer 508 and passing the interpolated pixel data to frame buffer processor circuitry 514 through frame buffer I/F 512.

Returning to FIG. 6, now that an output image is generated (S614) a check is performed to see if the output image is complete (S616). For example, in the previous sections, the only subdivision that was completed was subdivision 920. Therefore, the check would be false, and the process would go back to the calculation of the coarse displacement and the input image block boundary process (S606). Once the entire output image has been generated (S616), method 600 stops (S618).

The relationship between image area 302 of FIG. 3, image data boundary 702 of FIG. 7, sub-division 902 of FIG. 9 and subdivision 1314 of FIG. 13 will now be reviewed with reference to FIG. 14.

FIG. 14 illustrates the relationship between a frame, a block, a coarse data sub-division area and a final pixel-level subdivision area in accordance with aspects of the present disclosure.

As shown, FIG. 14 includes a frame 1402, a block 1404, a coarse data sub-division area 1406 and a final pixel-level subdivision area 1408. Frame 1402 includes a plurality of blocks, an example of which is block 1404. Each block includes coarse data sub-division areas, an example of which is coarse data sub-division area 1406. Each coarse data sub-division area includes a plurality of final pixel-level subdivision, an example of is pixel-level subdivision 1314.

Frame 1402 corresponds to and image area, for example image area 302 discussed above with reference to FIG. 3. Block 1404 corresponds to an image data boundary, for example image data boundary 702 discussed above with reference to FIG. 8. Coarse data sub-division area 1406 corresponds to a stage of sub-division, for example sub-division 902 discussed above with reference to FIG. 9. Final pixel-level subdivision area 1408 corresponds to a final stage of subdivision, for example subdivision 1314 discussed above with reference to FIG. 13.

Conventional digital imaging systems have, proven to be slow and inefficient. Solutions such as parametric models and large remapping models for programmable engines take up too much bandwidth, cost, and time.

A system and method in accordance with the present disclosure uses mapping tables without compromising performance. The back-mapping provides a coarse mapping from output to input coordinates. This coarse mapping uses much less processing power than conventional systems. Further, this coarse mapping is scalable, wherein the number of subdivisions is directly proportional to the amount of processing power required and is directly proportional to the decrease in distortion. As such, more distortion may be corrected by increasing the number of subdivisions, which will also increase the processing power requirement. A subsequent interpolation avoids the need for full remapping table of each pixel. This method of back-mapping and interpolation addresses distortions generated by lenses, and does so with less resources and power than conventional systems.

The foregoing description of various preferred embodiments of the disclosure have, been presented for purposes of illustration and description. It is not intended to be exhaustive or to limit the disclosure to the precise forms disclosed, and obviously many modifications and variations are possible in light of the above teaching. The example embodiments, as described above, were chosen and described in order to best explain the principles of the disclosure and its practical application to thereby enable others skilled in the art to best utilize the disclosure in various embodiments and with various modifications as are suited to the particular use contemplated. It is intended that the scope of the disclosure be defined by the claims appended hereto.

What is claimed as new and desired to be protected by Letters Patent of the United States is:

1. An image venerator for generating an output image, the image generator including:
frame buffer processor circuitry operable to receive input image data associated with an input image that is associated with an input matrix of pixels, the input image data including input pixel data corresponding to each pixel of the matrix of pixels, respectively;
image area dividing processor circuitry operable to provide an output image area for the output image and to divide the output image area into a plurality of subdivisions, the output image being associated with an output matrix of pixels;
back-mapping processor circuitry operable to select an output pixel location in the output image area the selected output pixel location corresponding to one of the plurality of subdivisions; and
in which the back-mapping processor circuitry is further operable to select one of the input matrix of pixels based on the selected output pixel location and the location modification data and to associate the input pixel data of the selected one of the input matrix of pixels with the selected output pixel location.

2. The image generator of claim 1, including interpolating processor circuitry operable to interpolate pixel data for an output pixel coordinate.

3. The image generator of claim 2, including transform processor circuitry having stored therein, location change data as fisheye data associated with the one of the plurality of subdivisions of the image area.

4. The image generator of claim 2, including a transform processor circuitry having stored therein, location change data as pincushion data associated with the one of the plurality of subdivisions of the image area.

5. The image generator of claim 2, including transform processor circuitry having stored therein, location change data as barrel data associated with the one of the plurality of subdivisions of the image area.

6. The image generator of claim 2, including transform processor circuitry having stored therein, location change data as spherical data associated with the one of the plurality of subdivisions of the image area.

7. The image generator of claim 2, including transform processor circuitry having stored therein, location change data as chromatic, data associated with the one of the plurality of subdivisions of the image area.

8. A method including:
receiving, via frame buffer processor circuitry, input image data associated with an input image, the input image data corresponding to a matrix of pixels in an image area;
selecting, via image area dividing processor circuitry, a pixel within the matrix of pixels, the selected pixel having an input pixel coordinate within the image area;
associating, via back-mapping processor circuitry, the selected pixel with a corresponding one of a plurality of subdivisions of the image area;
storing, via transform processor circuitry, location change data associated with the one of the plurality of subdivisions of the image area; and
generating, via the back-mapping processor circuitry, an output pixel coordinate for the selected pixel based on the input pixel coordinate and the location change data.

9. The method of claim 8, including interpolation, via interpolating processor circuitry pixel data for an output pixel coordinate.

10. The method of claim 9, in which the storing, via transform processor circuitry, location change data includes storing the location change data as fisheye data associated with the one of the plurality of subdivisions of the image area.

11. The method of claim 9, in which the storing, via transform processor circuitry, location change data includes storing the location change data as pincushion data associated with the one of the plurality of subdivisions of the image area.

12. The method of claim 9, in which the storing, via transform processor circuitry, location change data includes storing the location change data as barrel data associated with the one of the plurality of subdivisions of the image area.

13. The method of claim 9, in which the storing, via transform processor circuitry, location change data includes storing the location change data as spherical data associated with the one of the plurality of subdivisions of the image area.

14. The method of claim 9, in which the storing, via transform processor circuitry, location change data includes storing the location change data as chromatic data associated with the one of the plurality of subdivisions of the image area.

15. A camera including:
a lens system arranged to create an image of an object, the image having a distortion;
a controller operable to provide a distortion signal based on the distortion;
frame buffer processor circuitry operable to receive input image data associated with an input image that is associated with an input matrix of pixels, the input image data including input pixel data corresponding to each pixel of the matrix of pixels, respectively;
image area dividing processor circuitry operable to provide an output image area for the output image and to divide the output image area inter a plurality of subdivisions, the output image being associated with an output matrix of pixels;
back-mapping processor circuitry operable to select an output pixel location in the output image area, the selected output pixel location corresponding to one of the plurality of subdivisions; and
in which the back-mapping processor circuitry is further operable to select one of the input matrix of pixels based on the selected output pixel location and the location modification data and to associate the input pixel data of the selected one of the input matrix of pixels with the selected output pixel location.

16. The camera of claim 15,
in which the lens system includes compound lens system operable to move in order to focus the image, and
in which the controller is operable able to detect a position of the compound lens system and to generate the distortion signal based the specific position of the compound lens system.

17. The camera of claim 15, in which the lens system is removable.

18. The camera of claim 15, including interpolating processor circuitry operable to interpolate pixel data for an output pixel coordinate.

19. The camera of claim 18, including transform processor circuitry having stored therein, location change data as fisheye data associated with the one of the plurality of subdivisions of the image area.

20. The camera of claim 18, including a transform processor circuitry having stored therein, location change data as pincushion data associated with the one of the plurality of subdivisions of the image area.
